(19) United States
(12) Patent Application Publication
(10) Pub. No.: US 2015/0242504 A1
(43) Pub. Date: Aug. 27, 2015

(54) AUTOMATIC CONTEXT SENSITIVE SEARCH FOR APPLICATION ASSISTANCE

(71) Applicant: Microsoft Corporation, Redmond, WA (US)

(72) Inventor: Phillip Mark Profitt, Tokyo (JP)

(73) Assignee: Microsoft Corporation, Redmond, WA (US)

(21) Appl. No.: 14/191,196

(22) Filed: Feb. 26, 2014

(51) Int. Cl. G06F 17/30; G06F 9/44; G06F 3/0484

(52) U.S. Cl. CPC G06F 17/30864; G06F 3/04842; G06F 9/4446

(57) ABSTRACT

A system and method of providing help to an application user by generating a context-based help search for publically available help information made available by third parties on public networks. The system and method determine whether a user would benefit from assistance in using a primary computing application and a context of use of the primary computing. A context-based a search query is executed to retrieve publically available network resident help information relating to the needed help, and the results are output to a display.

### BACKGROUND

Users of applications such as audiovisual games are presented with a number of challenges designed to enhance their enjoyment of the game. Players often reach points in the game when they have difficulty passing a particular challenge. Games present users with various levels of difficulty, which makes passing one stage at a novice level different than passing the same challenge at a more difficult level. Some users resort to searching for help via the Internet. Often, third parties post written descriptions and gameplay videos of “walk through” depicting how to pass a particularly difficult stage in a game. Normally, this means the user must stop game play, construct a search, and view the help before returning to the game. The user usually has limited information about the context of where they are in the game (for example, what the name of the area is, what boss they are encountering) which makes it difficult for the user to build a search query themselves.

### SUMMARY

Technology is presented which provides a user of an application with assistance when using the application by accessing help information available from third party sources or a dedicated help database when the user encounters a problem in the application. The technology has particular applicability to gaming applications where a user may find themselves troubled by a particular scenario or task in the game that they cannot overcome without help. A system and method of providing help to an application user generates a context-based help search for publically available help information made available by third parties on public networks. The system and method determine whether a user would benefit from assistance in using a primary computing application and a context of use of the primary computing. A context-based a search query is executed to retrieve publically available network resident help information relating to the needed help, and the results are output to a display

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a flow chart illustrating a method in accordance with the present technology.

FIG. 2A illustrates a first variation on the method of FIG. 1.

FIG. 2B illustrates a second variation on the method of FIG. 1.

FIGS. 3A-3E are block diagrams illustrating systems suitable for implementing the present technology and data flows between the systems.

FIG. 4 is a flow chart illustrating a process for determining whether a user needs help in an application.

FIG. 5 is a flow chart illustrating a process for determining whether a user needs help using a real time event system.

FIG. 6 is a flow chart illustrating a method for determining a context of a user in an application.

FIG. 7 is a flow chart illustrating a first method of creating a search query.

FIG. 8 is a flow chart illustrating a second method of creating a search query.

FIG. 9 is a flow chart illustrating a process providing an output of search results to a device.

FIG. 10 is a flow chart illustrating one method of creating a search query with multiple devices.

FIG. 11 is a block diagram of a real time event system.

FIG. 12 is a block diagram of a first processing device suitable for implementing the present technology.

FIG. 13 is a block diagram of a second type processing device suitable for performing the present technology.

FIG. 14 is a block diagram of the third type processing seemed device suitable for implementing the present technology.

### DETAILED DESCRIPTION

Technology is presented which provides the user of an application with context relevant help. The context relevant help is provided based on information is made available by third parties and which is accessible by searching publicly available sources or a collection of the publicly available sources stored in a database provided by a multiuser application service. A determination is made that a user needs help in an application and the context of the user's progress or work in an application is determined. A context-based search query is executed against publically available help information and the results are returned to the application user on the same processing device or a companion processing device. The technology is particularly advantageous to game players having difficulty passing achievements where numerous third parties have provided instructions on how to complete troublesome tasks. While the technology is advantageously used in games, the technology may be used with any of a number of types of applications.

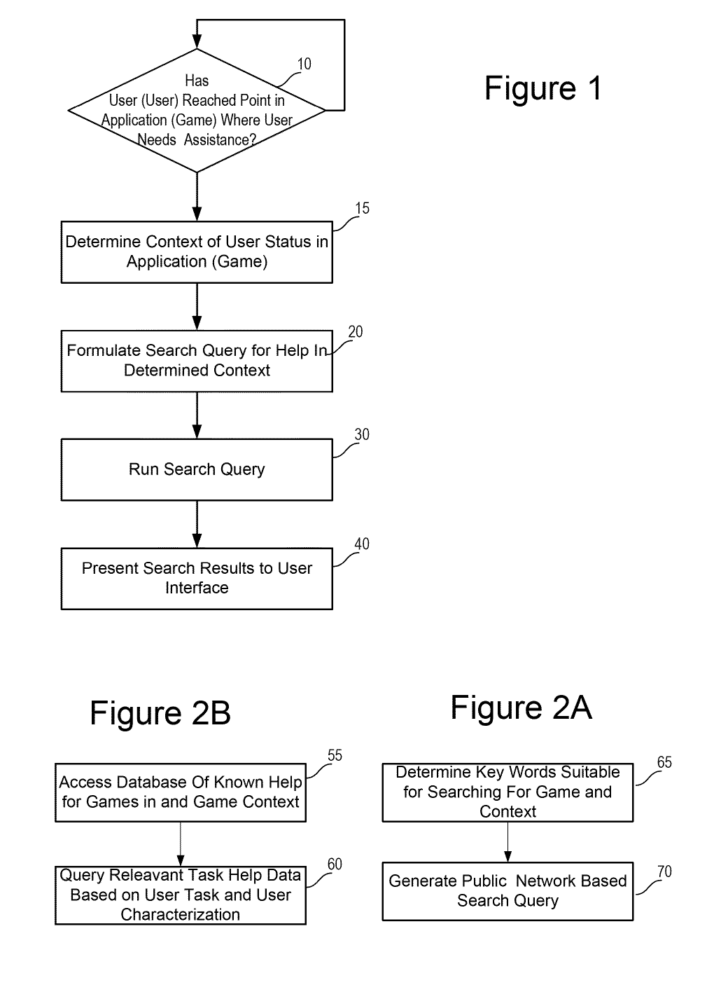

FIG. 1 is a flowchart providing an overview of the present technology. The method of FIG. 1 illustrates general steps which may be performed by one or more processing devices as illustrated herein. In the context of this disclosure, the technology will be described in relation to performance of a primary application operating on a primary processing device. The application may be any type of application capable of execution on the primary processing device. The technology is particularly applicable to gaming applications where users may seek help in completing in-game achievements and failure with respect to certain game aspects can be detected by repetitive failures to complete certain stages of a game. Hence, the terms player and user are used synonymously.

At 10, a determination is made as to whether or not a user has reached a point in the application with a user needs assistance. Methods for determining whether or not a user has reached a point in an application where user needs assistance are described herein. If the determination at 10 is that the user needs assistance, then the context of the user status within the application is determined at 15. The user's context in an application comprises information surrounding the nature of the issue the user is having in the application. Where the application is a game, the context may include a point in the game where the user has a problem competing a particular task. In story based games, checkpoints are provided in the game which mark a user's progress through the particular game story. Generally, there are tasks in the story which must be completed in order to reach a next checkpoint or achievement. In addition, a user's status within the game may be reflected by user skill level, in game inventory, play history and record in completing previous tasks. All such information comprises the context of the game. When a user reaches a particular point in the application where a user repeats the same in-applications tasks without success, a determination can be made as the game context and a search developed around terms related to the particular application and task. Hence, in a game application, a user skill level, user inventory, game level, and other aspects of the context are determined at 15.

Once the user context within the game is determined at 15, then a search query for help within the determined context is formulated at 20. The search query, as discussed below, can be run by any one of a number of standard commercial search engines which access publicly available, network based data sources, to seek help information. In another embodiment, a search quire is formulated to run against a database which collects help information from the publicly available data sources and categorizes the data in one or more ways, including, for example, organizing the data by application and application context. Examples of publicly available network based data sources include websites, web videos, blogs, and other published information where other users or users have provided descriptions and/or demonstrations of how to achieve a particular task in the context of the application.

At 30, the query formulated at 30 is run to retrieve a listing of potential help results. In one embodiment, a listing of results may be provided to the user as a result of the search at 40. When a user selects one of the results for presentation, the result is rendered in an interface for the user.

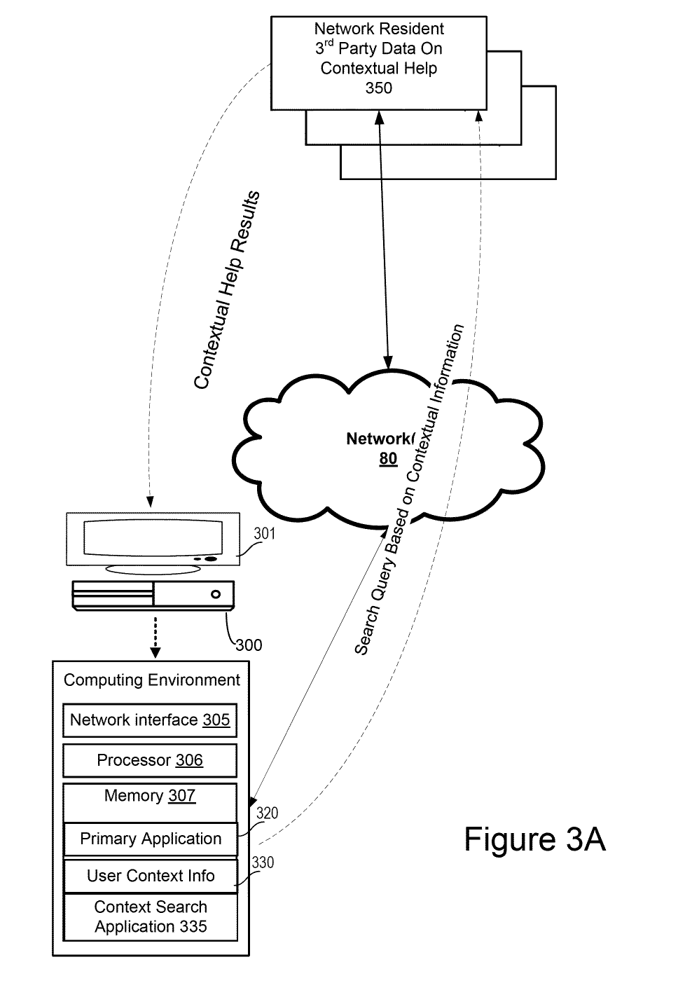

FIGS. 2A and 2B illustrate two alternatives for formulating a search query at 20. In FIG. 2A, a first type of query includes a search against publically available network resources using key words. At 65, a determination of the context provides a number of key terms which, when provided to a search engine, generate results showing context based help for the application. Using the context based key words, a public network search query is generated at 70. The query may be run on a commercially available search engine. FIG. 2b illustrates an alternative where a search is created for a database of publically available help information. A database of publically available help information may be created and maintained by a multiuser service provider. An example of a multiuser service provider is the XBOX LIVE® service provided by Microsoft Corporation. The database may contain links to public addresses where the publically available help information is provided, or may cache various copies of the publically available information for provision directly to the searching device. Where such a database exists, a set of learned information for each application will be created over time, showing trends on where users typically need help. In addition, a common set of search terms may be provided as well as a characterization of the application structure. For example, a database may be organized in relation to the achievements sought in a particular game. As such, at 55, a search may first access the database of known help information by accessing the known structure of the application and a structured query may be provided at 60 to query relevant task data specific to an issue the user is having and the user's characterization in the application.

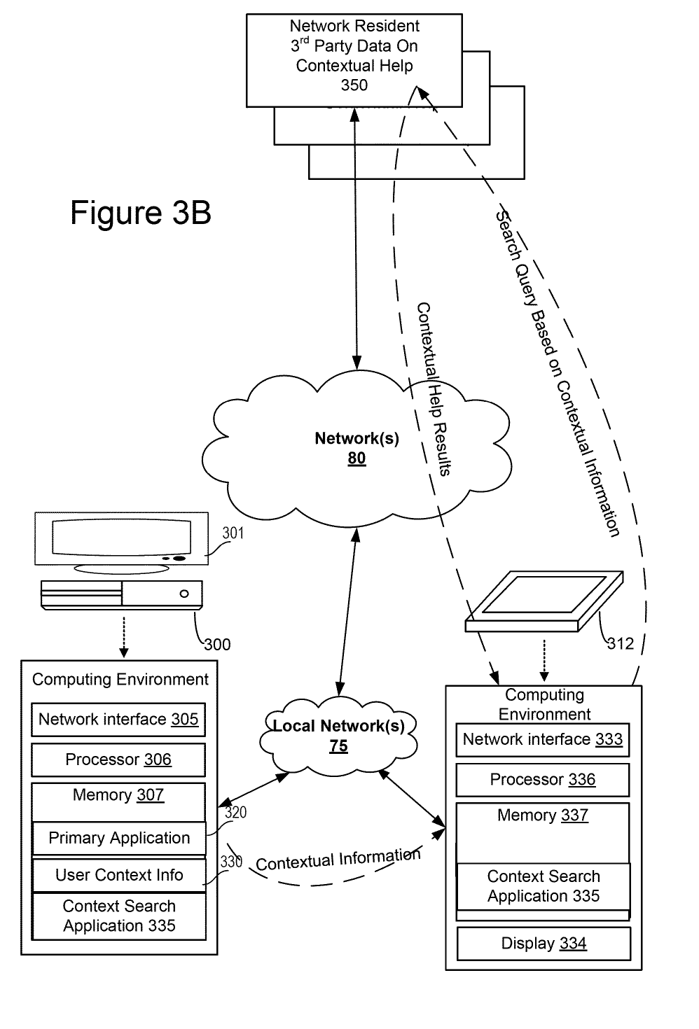

FIGS. 3A through 3E illustrate various processing devices and the data flows between the devices for various embodiments of the present technology. As described in FIGS. 3A through 3E, various types of devices may be utilized to run primary applications and provide context-based help information. Context-based help information may be provided on a processing device executing a primary application or a secondary, companion device utilized by the user of the primary application and the primary application device. In FIGS. 3A-3E, data connections between the devices are illustrated by solid lines while data flow is represented by dashed lines—it should be understood that actual data flow in the Figures may be through physical or wireless connections between the devices themselves or via the networks represented therein.

FIG. 3A illustrates a first embodiment of the technology wherein a computing environment 300 is utilized to execute a primary application and to provide context-based help information. A context-based search query relevant to the execution of the primary application is issued by the computing environment 300 to network resident third-party data 350 for contextual help running the primary application, and the results presented on the computing environment 300.

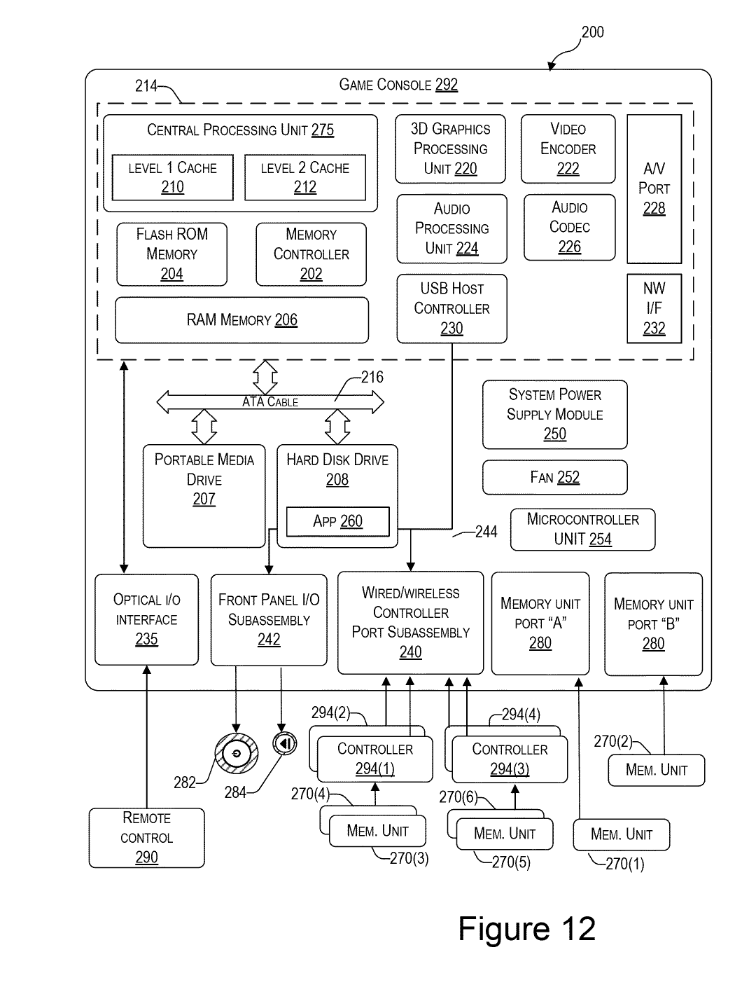

FIG. 3A illustrates a computing environment 300 and network resident third-party data 350 accessible via network 80. Network 80 represents a series of public and/or private networks such as the Internet allowing communication between the computing environment 300 and network resident third-party data 350. It should be understood that while only one computing environment 300 is illustrated, a plurality of computing environments simultaneously executing searches for the network resident third-party data 350 may be utilized in accordance with the technology. Computing environment 300 may comprise one of the computing devices illustrated in FIGS. 12-14 herein. In addition, it should be understood that the network resident third-party data 350 may be provided on one or more processing devices such as those illustrated in FIGS. 12 through 14.

Computing environment 300 is utilized to execute a primary application 320 by an application user. (The application user is not illustrated.) Commuting environment 300 generally includes network interface 305, a processor 306, and a memory 307. Memory may include, for example, a primary application 320, user context information 330 and a context-based search application 335. A display 301 may be coupled to the computing environment 300. The primary application 320, when executed, will provide a context of the user's performance within the application. This context information 330 may be maintained by the application or may be derived by accessing information provided by the application. In another embodiment, the context information is derived from events distributed by the application to a multi-user event service. A user context-based search application 335 can communicate via network 80 with network resident third-party data 350. Network resident third-party data 350 may be provided on one or more servers or websites which provide access to third party generated information on the user of the primary application, including descriptions, presentations, illustrations and tutorials on how to complete tasks in the primary application, all of which are accessible using standard standard information protocols. Context-based search application 335 can utilize a standard web search engine, such as Microsoft's BING® search engine or the Google® search engine, to access network resident third-party data 350. Alternatively or in addition, context-based search application 335 may incorporate its own search technology. A context-based search result can provide an output known to average users comprising a listing of the results retrieved, with hyperlinks in the list which retrieve the content and display the content in known rendering media. Such rendering media may include a web-browser with known plug-ins for rendering graphics, audio and video information.

When a determination that help for the primary application is to be obtained context-based search application 335 will generate a search based on the context information 330 via network 80 against the network resident third-party data 350. Potential help results are returned to a user interface on display 301 provided by the computing environment.

In the embodiment of FIG. 3A, the computing environment 300 both executes the primary application and initiates and retrieves the results of the contextual search information.

FIG. 3B illustrates an alternative embodiment of the present technology were in a companion computing environment 312 is utilized. The companion computing environment 312 generally includes network interface 333, a network processor 336, memory 337, and a display 334. Companion computing environment 312 may include other elements such as a camera 338, sensors 339 and display 334. As illustrated in FIG. 3B, the companion computing environment 312 is a tablet device, but any type of processing device, including computing environment 300 and those devices illustrated in FIGS. 12-14 may act as a companion computing environment in this context. FIG. 3B also illustrates a local network 75 connects computing environment 300 and computing environment 312. It should be understood that local network 75 may be a private network which itself connects to network 80. It should be further understood that the local network 75 need not be utilized in the embodiment of FIG. 3B, but is illustrated to present a common configuration in which the subject matter of the technology may be used.

In the embodiment shown in FIG. 3B, contextual information is provided from the primary application to computing environment 312. Companion computing environment 312 includes a context-based search application 335 which generates the search based on the contextual information against the network resident third-party data 350. Contextual help results are returned to companion computing environment 312 for presentation on display 334 of computing environment 312.

In yet another embodiment, the same configuration illustrated in FIG. 3B may return the help results to computing environment 300 rather than companion computing environment 312.

FIG. 3C illustrates yet another embodiment wherein a multiuser application service provides a contextual help database of network resident third-party data 350. In this embodiment, contextual information is provided from the competing environment 300 to computing environment 312. Context based search application 335 on computing environment 312 runs a search against the contextual help database 360 and context-based help results are provided to the companion computing environment 312. The results may alternatively be provided to computing environment 300 as in the embodiment in FIG. 3A. Multiuser application service 370 may generate a repetitive search to update database 360. The contextual help database 360 can be updated for each search generated by computing environment 312 as result of receiving context information 330 for each event, or information in the database 360 can be up dated at intervals by the multiuser application service 370. For example, the multiuser application service 370 can update the database continually so that searches requested by computing environment 312 always receive most up-to-date information available in the network based third-party data 350.

In the embodiment shown in FIG. 3C, the search is generated by a context-based search application 335 operating on the computing environment 312. It should, however, be recognized that the context-based search application 335 can be resident on the computing environment 300 to search database 360 and no companion computing environment 312 used. In still another embodiment, the search can be generated by competing environment 312 and the results provided back to competing environment 300.

FIG. 3D illustrates an embodiment of the technology wherein a multiuser application service provides a real time event service 380. In FIG. 3D, event data from the application 320 is provided to an event service 102. Third party application and context-based search application 335 may subscribe to events and statistics provided by the event service 102 and obtain user contextual information to an event service 380. Event service 380 provides a number of application programming interfaces and data feeds allowing any computing environment, such as companion computing environment 312, to access events generated by primary applications 320. In this embodiment, application 335 may subscribe to the service 102 and searches are generated from the application 335 on computing environment 312 responsive to the event data provided by event service 102. In this context, searches can be run directly against the third-party data 350 resident on the network 80. In the embodiment shown in FIG. 3E, a contextual help database 360 is also provided on the multiuser application service and contextual help search may be run against the contextual help database 360.

As illustrated in FIGS. 3D and 3E, search results are returned to the competing environment 312. As noted above, search results can be provided back to competing environment 300 directly.

Given the various embodiments illustrated in FIGS. 3A-3E, it will be recognized that there are any number of configurations for distributing the event data and workload to generate the context-sensitive help search and return context-sensitive help results in accordance with the technology herein

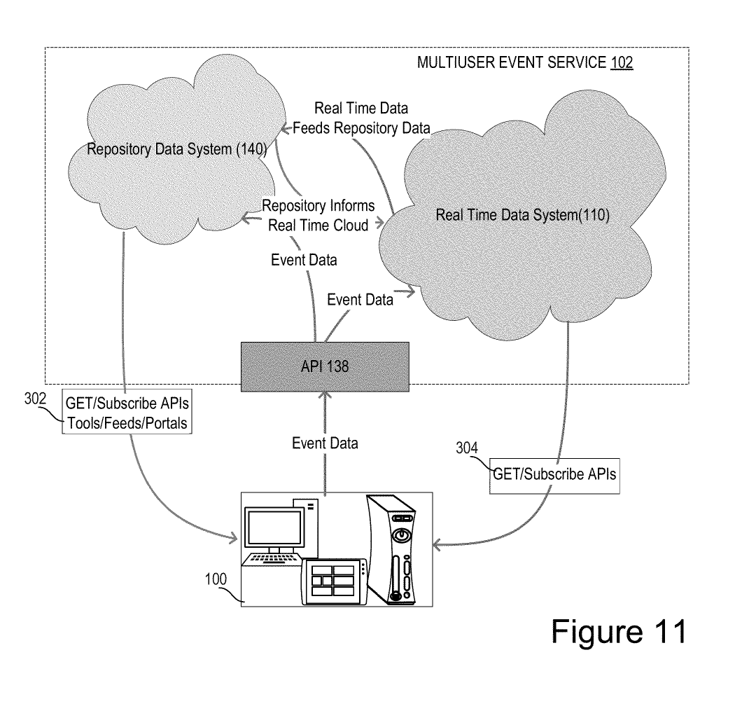

The technology may be used with an event service 102 provided by a multiuser application service 370. Any type of applications which can be developed by a primary application developer, and for which supplemental application developers would desire to develop secondary applications, can benefit from the technology described herein. FIG. 11 illustrates an event service 102 which is coupled via a network 80 to one or more processing devices 100 (including computing environments 300, 312).

Real time event service 102 includes a real time data system 110, a repository data system 140, a game management service 126, a user authentication service 124, an API 138, and user account records 130. Applications are generally executed on processing device 100, and the primary applications (such as games) generate and output application events. In accordance with the technology, discrete or aggregated events are transmitted to the real time event service 102 and to secondary applications such as search application 335 executing on other processing devices, such as computing environment 312. Examples of events are those which may occur in the context of a game. For example, in a racing game, top speed, average speed, wins, losses, placement, and the like are all events which may occur. In an action game, shots fired, scores, kills, weapons used, levels achieved, and the like, as well as other types of achievements, are all events that may occur. In one embodiment, statistics are generated for events by the multiuser gaming service.

Components of the multiuser event service 102, including a repository data system 140 and real time data system 110 as well as API 138, are illustrated along with event flow and dataflow between the systems. As event data is generated by primary application processing device 100, the events are collected by service 102 transmitted through the API to both the repository data system 140 and the real time data system 110. This event data is transformed and maintained by the real time data system 110 and the repository data system 140. Through get/subscribe APIs 302 304, information is returned to the processing devices 100. Real time data system 110 feeds repository data system 140 with event and statistic information created by the real time data system 110 for use by the repository data system in tracking events and verifying the accuracy of information provided by the real time data system 110. The repository data system, in turn, updates the real time data system 110 with any information which it deems to have been lost or needs correcting.

Real time data system 110 provides real time game information in the form of events and statistics to the secondary application developers who may build applications to use the service, as well as the repository data system 140. Applications such as context-based search application 335 are secondary in that they support the functions of the primary applications 320. Real time data system 110 receives event data from a plurality of running primary applications on any of a number of processing devices and transforms this events into data which is useful for secondary application developers. The statistics services may be provided by the application service and provide different types of statistics and information to the third party application developers. Another example is a leaderboard service for achievements within the event service 102 or individual games. Additional details of the multiuser application service may be found in U.S. application Ser. No. 14/167,769 entitled APPLICATION EVENT DISTRIBUTION SYSTEM (commonly owned by the assignee of the present application).

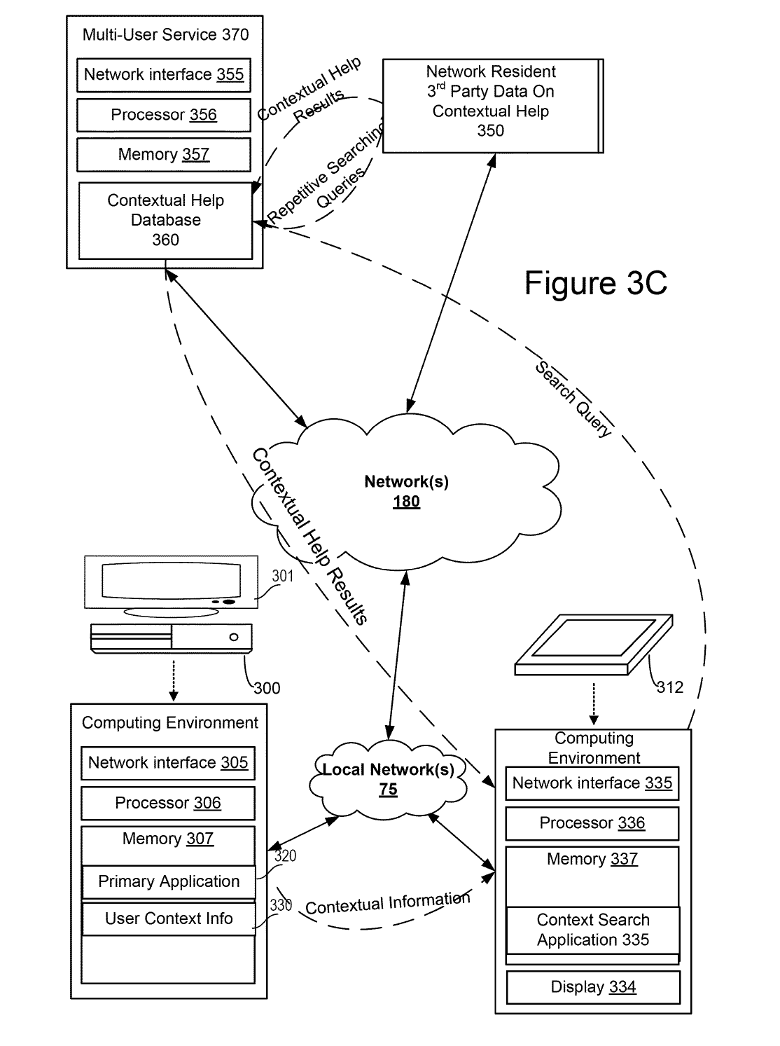

FIGS. 4-10 are illustrate various techniques for completing the steps shown in FIG. 1. FIG. 4 is a flowchart illustrating a method for determining whether a user needs assistance in the performance of an application. In one embodiment, FIG. 4 provides a method of completing step 10 in FIG. 1.

At 402, data concerning the user's performance of the application is received. As noted above, the information may be received by a search application such as application 335 running on the same processing device as the application or a companion computing environment 312 accessible to the user of the application. The data may be received from the primary application directly, via an API provided by the primary application or the event service 102 as described herein. At 404, a user's position within the application is detected. This may comprise detecting a user's position within a game, and determining the context of the user's position. The user's context in an application comprises information surrounding the nature of the issue the user is having in the application. At 406, a determination is made as to whether not a user has repeated a particular task or challenge in the application over a threshold number of times. For example, if the user has attempted to pass a particular achievement, but has not been successful, the determination at step 406 will register affirmative. It should be recognized that a number of alternatives exist for the threshold and the task which may be determinative of whether help is needed. In some cases, a single failure or incomplete task may be sufficient to initiate a search. In other cases, a higher number of failures is used. If the user has not repeated a task or challenge of threshold number of times, a determination may be made as to whether or not some other determiner of user help may be made at 408. For example, in the user interface of the application, a selector allowing user to request help from the context-sensitive search application to thirty-five may be provided. If either 406 or 408 are affirmative, then help search is initiated at 410.

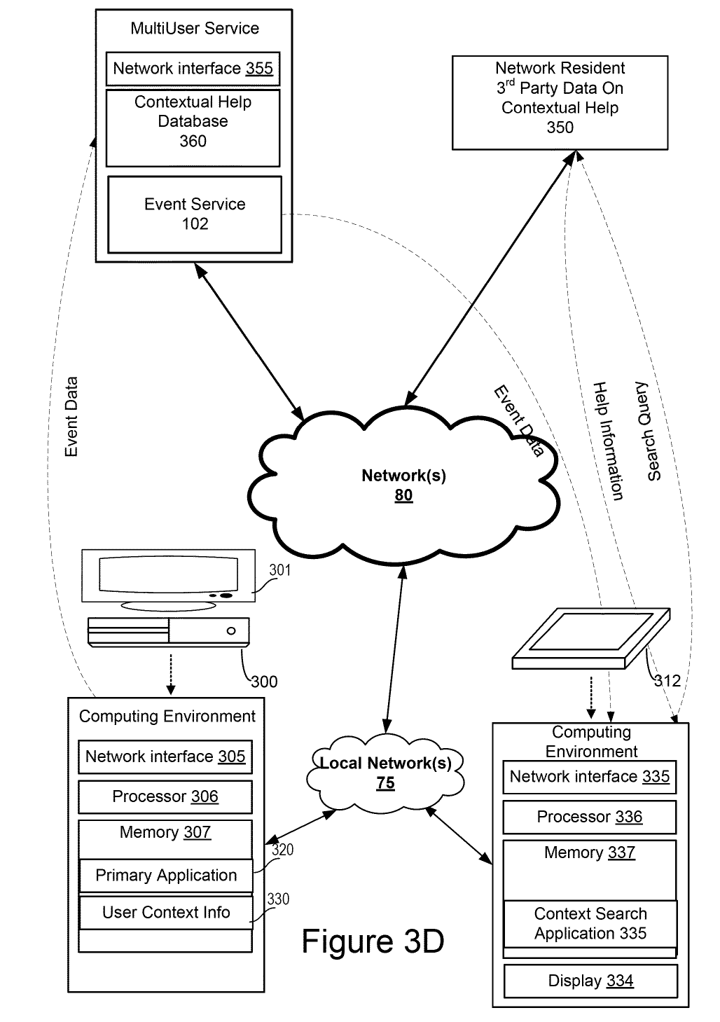

FIG. 5 illustrates additional steps of method for determining where a user needs help when an event service 102 is used in the system described above. At 412, for any application subscribed to service 102, an event or statistic stream from the real time event service 102 is accessed at 414. One component of the service 102 may be to generate a help needed statistic. The help needed statistic or event may be in indicator generated by the service 102 using the techniques of steps 406 or 408, or a manual request by a user that can initiate a context-based help search. If the help needed statistic is available at 416, then at 418 a determination can be made that help is needed from the events are statistics provided. This can directly initiate help search at 410. If the help needed statistic is not available, then the events provided by the event service 102 can be provided to the determinations at steps 406 and 408 to determine whether or not to initiate help search at 410.

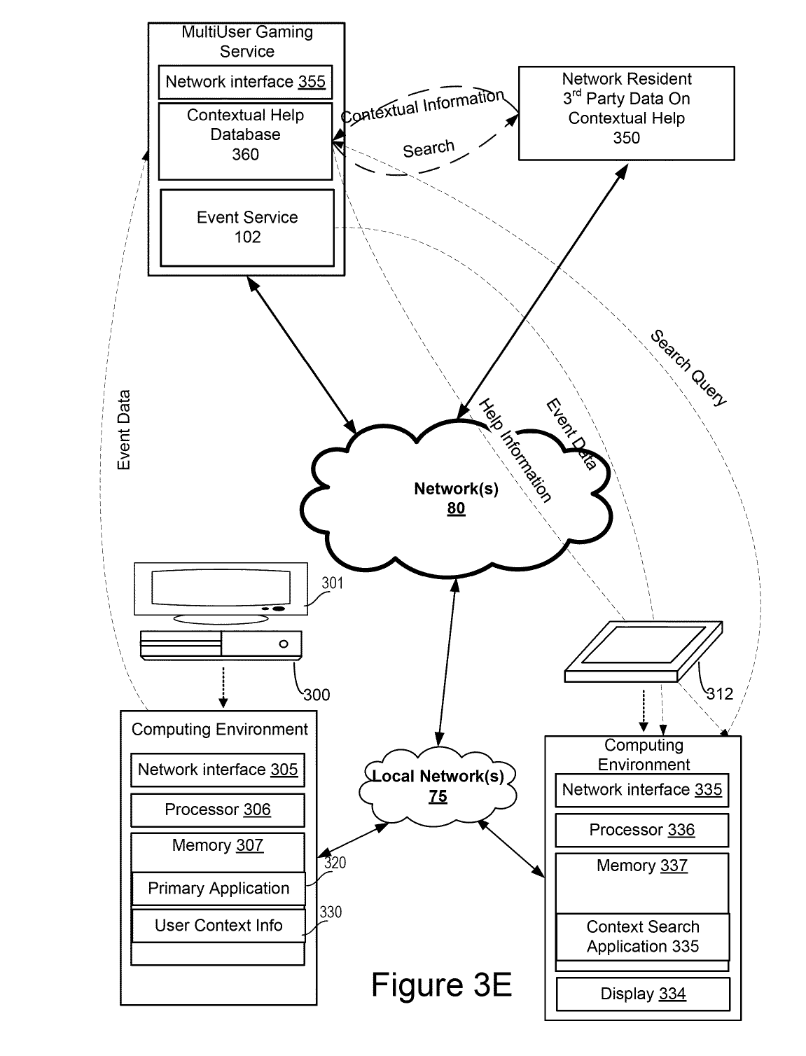

FIG. 6 is a flow chart illustrating a method for completing step 15 of FIG. 1 to determine the context of user status in the application. At 622, a determination be made as to the user task which needs to be completed based on the application context data and, in one option, known trouble points in the application performance. In the context performing certain games, after repeated gameplay by multiple users, knowledge can be gathered as to whether users typically find difficulty in achieving certain aspects of the game. This can be used to add to the context data determination in either the contextual help database or the context-based search application 335. For example, the application 335 may be updated over time with data on previous effective searches and results used by other users for particular tasks, thereby increasing the efficiency of the context based searching in future searches. At 624, the objective of the task is determined. Some objectives will require one to perform certain actions, or to feature components in the game. At 626, determination is made as any incremental steps and requirements, if any, which are necessary to complete the task. For example, it may not be possible to defeat a particular opponent in a racing game or a combat game without a particular car or particular weapons. An incremental step may be to obtain the car or tools necessary to complete the ultimate objective or task determined at 624. At 628 and determination is made as to what the actual user equipment and capabilities in the application, and whether not these equipment or capabilities meet the task incremental steps determined at 626. This context information can be utilized to develop the keywords necessary to perform the context help search in accordance with the technology.

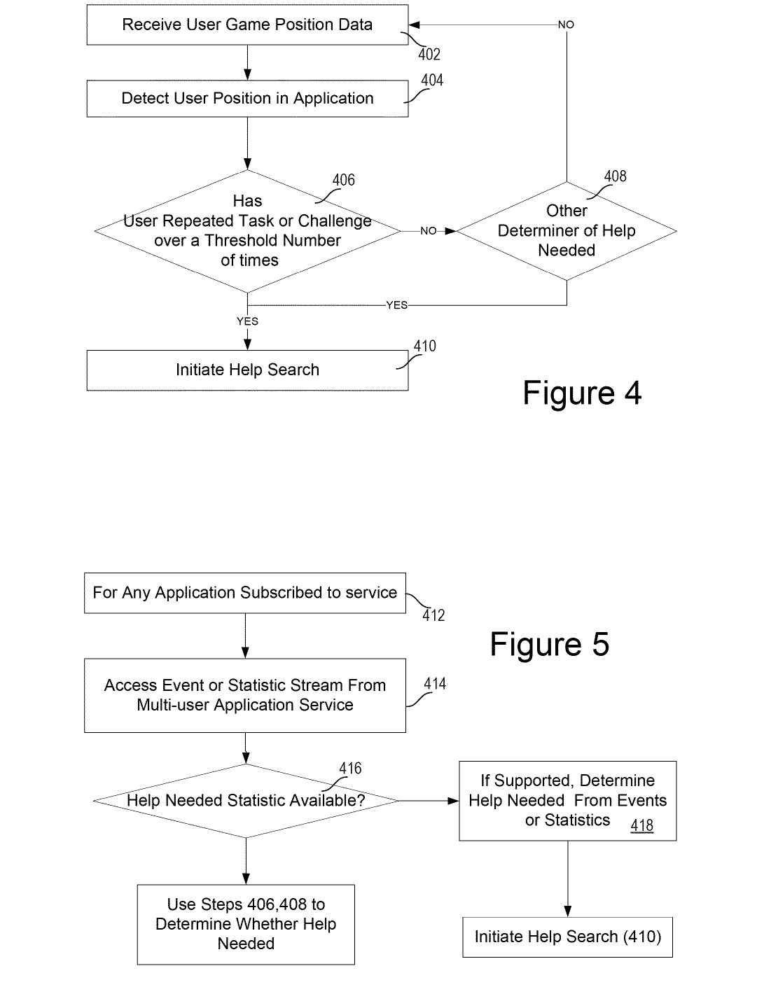

FIG. 7 is a first embodiment for formulating a search query at step 20 in FIG. 1 where the query is to be run against network resident third party data 350. The search can be performed correctly by one of the processing devices and application 335, or by the multiuser application service 370 when updating a multiuser context help database 360. At 722, potentially relevant keyword search terms relevant to the game are gathered. Examples include the game title, a sequence, milestone or achievement within game referenced to the user, the achievement sought, and/or checkpoint name. It should be recognized that any number of different types of keywords may be determined at 722. At 724, a determination is made whether particular limiters are necessary for each application. Certain games and applications utilize titles and words which are very common and which, when searched, would return incomplete or overreaching results. For example, a game with the title “open wheel racing” might retrieve results both about the game as well as the sport of racing. Search limiters for titles with common words, or immensely popular games, may include place the game title in specific quotes to limit the search to an exact phrase, or adding terms to identify the particular platform of the processing device or particular application versions. At 726, the specific search terms for the application is created. Subsequently, after testing, additions or revisions to the context relevant search terms derived from 722 may be provided at 728.

In some embodiments, steps 722-726 are performed by an application. In other embodiments, searches can be culled for particular primary application by creating a reference library of searches authored by human search specialists. In such an embodiment, searches may be tested and revised before provision in a search reference database accompanying the application 335, and context based searching performed by reference to the human constructed searches or search strings which may be later combined for specific application contexts. For example, a search for data on the game Halo may begin with a limited string of “Halo for PC” to which is added a specific context such as “achievement one.” Thus, a resulting keyword query for the game may be, for example, “Halo for PC defeat achievement one.”

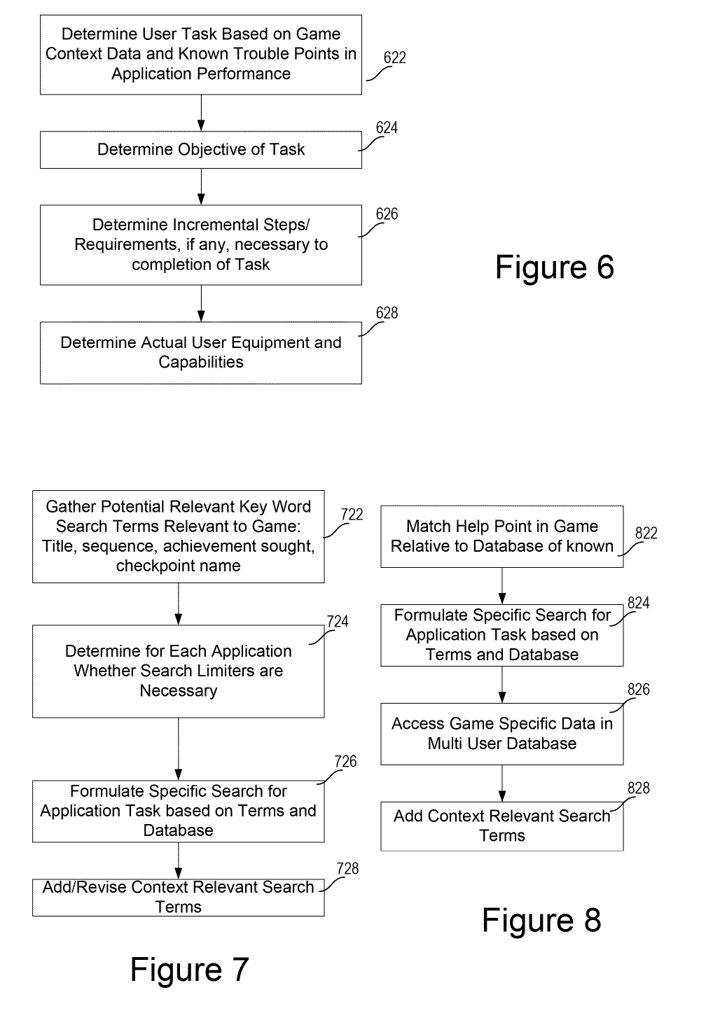

FIG. 8 is a second embodiment for formulating a search query 120 where the query is to be run against a search database such as database 360. A search configured to run against a specific help database may be slightly different in that the database and service may learn over time the particular points in the application where a user seeks help information. At step 822, the context point in the application is matched to the known series of help points which are known to be needed. A 824r, specific search for the application tasks based on terms and the database is formulated. At 826, game specific data in the help database relative to the point in the application context where the user seeks help is accessed. At 828, context relevant search terms may be added, including the specific characteristics of the users inventory at a particular point in the application.

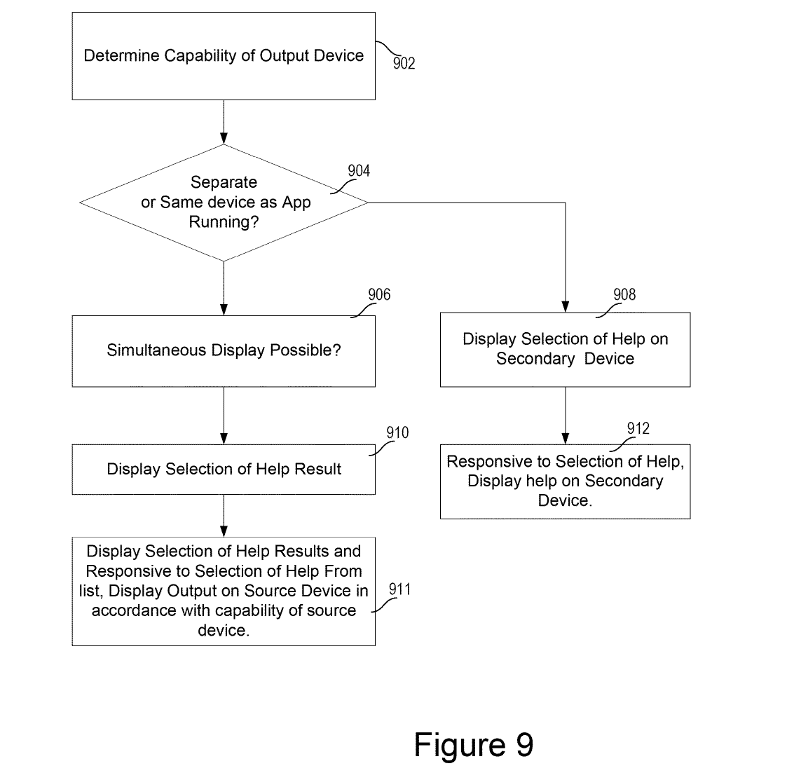

FIG. 9 is a flowchart illustrating a method for presenting search results to an output device as in step 40 of FIG. 1. At step 902, the capabilities of the output device are determined. The results of the search may provide both audio, video, text and images. Some devices may not include the capability of rending all types of audiovisual formats of help feedback. At 902, the method determines whether or not the device is capable of rendering each of the types of help which may be received by the search. At 904, a determination is made as to whether not the search is to be rendered on the same device or a separate device as the primary application for which help is requested is running. If the search results are to be provided on the same output device, (for example computing environment 300 of FIG. 3A) then a determination is made at 906 whether not simultaneous display of both the application and help as possible. For example, the Xbox ONE has the ability to display information in a “snap” window, and this would enable simultaneous display of the help and the primary application on the output device. At step 910, the search results are displayed the source device in accordance with its capabilities. This may include displaying the help in a separate section of the display, taking over the display completely, or waiting until the primary application has ceased executing and providing a separate display of the help at a time desired by the user. A selection of the help results retrieved is displayed on the device at 910 and at 911, responsive to the selection of the listed help items retrieved, the help resource is displayed on the primary application processing environment output device. If a separate or companion processing device is used to display the results of search, then a selection of the help results retrieved is displayed on the secondary device, and at 912, responsive to the selection of the listed help items retrieved, the help resource is displayed on the companion processing environment output device.

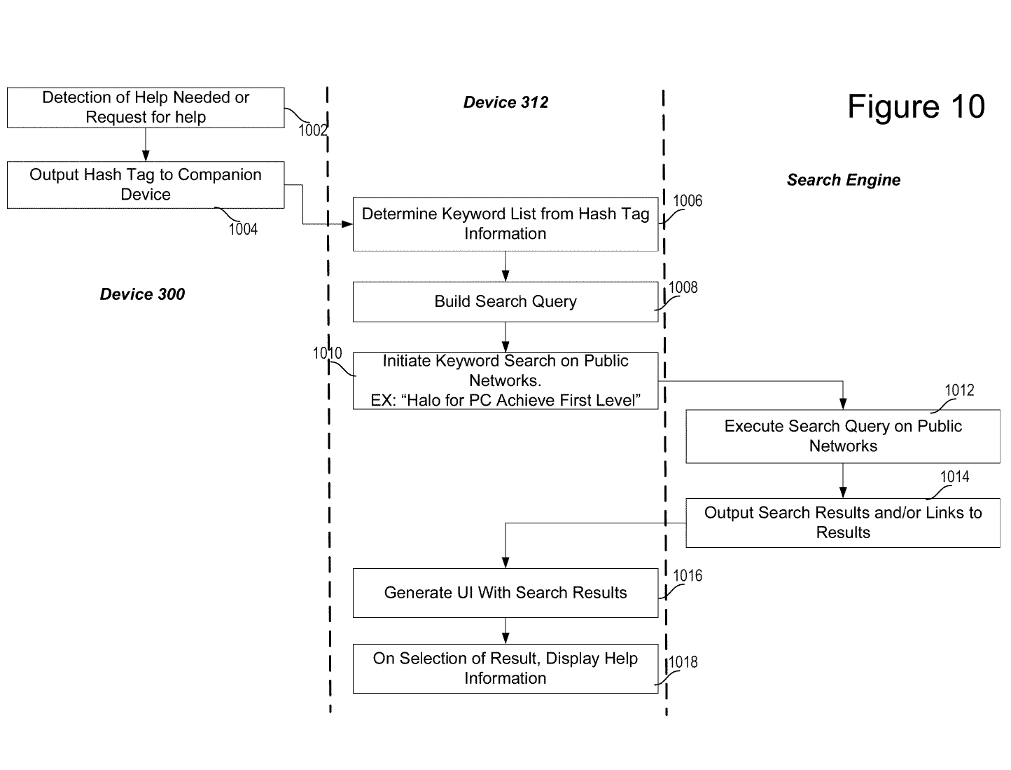

FIG. 10 is a flowchart illustrating one embodiment of the steps performed by each of computing environment 300, environment 312 and a search engine to execute a context-based help query. In one embodiment, each search application 335 may contain a table of queries or portions of queries for known applications that are associated with contexts for primary applications. Primary applications (or the event service, in one embodiment) may access the query table to retrieve full searches or search strings used to build full search queries. In yet another embodiment, the table is a hash table and hashes from the primary application indicate the context that the user needs help on within the application.

At step 1002, the detection of help needed to request for help is determined in accordance with FIG. 4. At step 1004, a hash tag identifying one or a number of search terms which can be used to build a search query is output to the companion device from the primary application processing environment such as environment 300. At step 1006, on the companion processing environment, a keyword list lookup is made by reference to the hash table. At step 1008, the search query is built from the keywords identified by the hash tag provided by the primary application device. At step 1010, a keyword search query on public networks is initiated by transmitting the query to a search engine. At 1012, the search engine executed the search query against the publically available network resident third-party data 350. At step 1014, the output of the search is returned to the companion device. At 1016, a user interface of search results is generated and upon selection resulted 1018, the help information is displayed on the companion device.

FIG. 12 is a functional block diagram of the gaming and media system 200 and shows functional components of the gaming and media system 200 in more detail. Console 292 has a central processing unit (CPU) 275, and a memory controller 202 that facilitates processor access to various types of memory, including a flash Read Only Memory (ROM) 204, a Random Access Memory (RAM) 206, a hard disk drive 208, and portable media drive 207. In one implementation, CPU 275 includes a level 1 cache 210 and a level 2 cache 212, to temporarily store data and hence reduce the number of memory access cycles made to the hard drive 208, thereby improving processing speed and throughput.

CPU 275, memory controller 202, and various memory devices are interconnected via one or more buses (not shown). The details of the bus that is used in this implementation are not particularly relevant to understanding the subject matter of interest being discussed herein. However, it will be understood that such a bus might include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

In one implementation, CPU 275, memory controller 202, ROM 204, and RAM 206 are integrated onto a common module 214. In this implementation, ROM 204 is configured as a flash ROM that is connected to memory controller 202 via a PCI bus and a ROM bus (neither of which are shown). RAM 206 is configured as multiple Double Data Rate Synchronous Dynamic RAM (DDR SDRAM) modules that are independently controlled by memory controller 202 via separate buses (not shown). Hard disk drive 208 and portable media drive 106 are shown connected to the memory controller 202 via the PCI bus and an AT Attachment (ATA) bus 216. However, in other implementations, dedicated data bus structures of different types can also be applied in the alternative.

A graphics processing unit 220 and a video encoder 222 form a video processing pipeline for high speed and high resolution (e.g., High Definition) graphics processing. Data are carried from graphics processing unit 220 to video encoder 222 via a digital video bus (not shown). An audio processing unit 224 and an audio codec (coder/decoder) 226 form a corresponding audio processing pipeline for multi-channel audio processing of various digital audio formats. Audio data are carried between audio processing unit 224 and audio codec 226 via a communication link (not shown). The video and audio processing pipelines output data to an A/V (audio/video) port 228 for transmission to a television or other display. In the illustrated implementation, video and audio processing components 220-228 are mounted on module 214.

FIG. 12 shows module 214 including a USB host controller 230 and a network interface 232. USB host controller 230 is shown in communication with CPU 275 and memory controller 202 via a bus (e.g., PCI bus) and serves as host for peripheral controllers 104(1)-104(4). Network interface 232 provides access to a network (e.g., Internet, home network, etc.) and may be any of a wide variety of various wire or wireless interface components including an Ethernet card, a modem, a wireless access card, a Bluetooth module, a cable modem, and the like.

In the implementation depicted in FIG. 12, console 292 includes a controller support subassembly 240 for supporting four controllers 294(1)-294(4). The controller support subassembly 240 includes any hardware and software components needed to support wired and wireless operation with an external control device, such as for example, a media and game controller. A front panel I/O subassembly 242 supports the multiple functionalities of power button 282, the eject button 284, as well as any LEDs (light emitting diodes) or other indicators exposed on the outer surface of console 292. Subassemblies 240 and 242 are in communication with module 214 via one or more cable assemblies 244. In other implementations, console 292 can include additional controller subassemblies. The illustrated implementation also shows an optical I/O interface 235 that is configured to send and receive signals that can be communicated to module 214.

MUs 270(1) and 270(2) are illustrated as being connectable to MU ports “A” 280(1) and “B” 280(2) respectively. Additional MUs (e.g., MUs 270(3)-270(6)) are illustrated as being connectable to controllers 294(1) and 294(3), i.e., two MUs for each controller. Controllers 294(2) and 294(4) can also be configured to receive MUs (not shown). Each MU 270 offers additional storage on which games, game parameters, and other data may be stored. In some implementations, the other data can include any of a digital game component, an executable gaming application, an instruction set for expanding a gaming application, and a media file. When inserted into console 292 or a controller, MU 270 can be accessed by memory controller 202. A system power supply module 250 provides power to the components of media system 200. A fan 252 cools the circuitry within console 292.

An application 260 comprising machine instructions is stored on hard disk drive 208. When console 292 is powered on, various portions of application 260 are loaded into RAM 206, and/or caches 210 and 212, for execution on CPU 275, wherein application 260 is one such example. Various applications can be stored on hard disk drive 208 for execution on CPU 275.

Gaming and media system 200 may be operated as a standalone system by simply connecting the system to a monitor, a television, a video projector, or other display device. In this standalone mode, gaming and media system 200 enables one or more users to play games, or enjoy digital media, e.g., by watching movies, or listening to music. However, with the integration of broadband connectivity made available through network interface 232, gaming and media system 200 may further be operated as a participant in a larger network gaming community, as discussed in connection with FIG. 1.

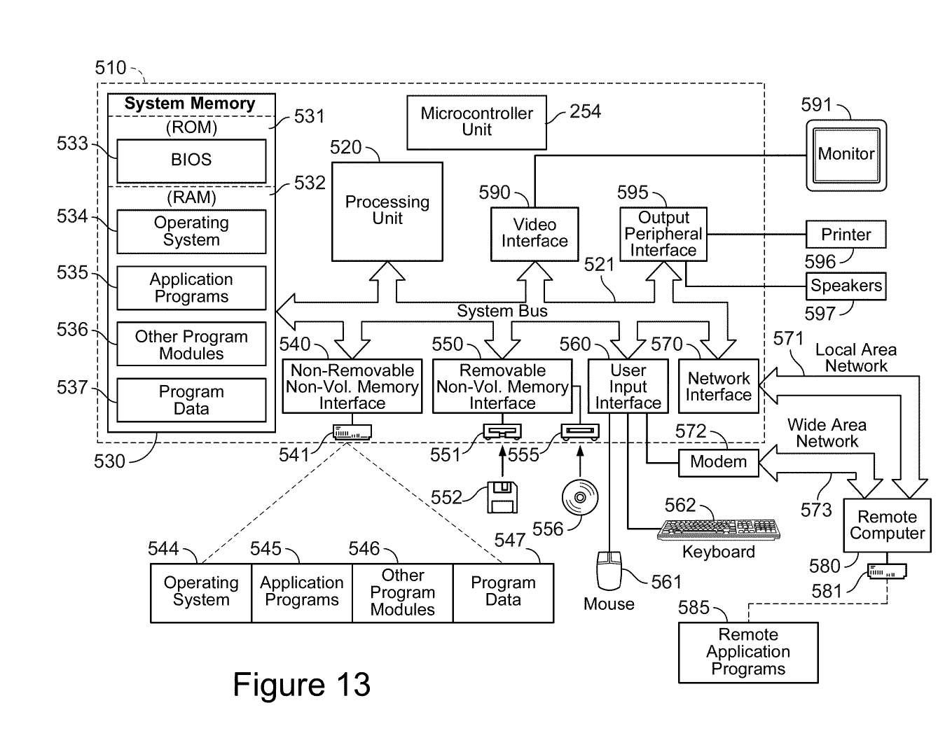

FIG. 13 illustrates a general purpose computing device for implementing the operations of the disclosed technology. With reference to FIG. 13, an exemplary system for implementing embodiments of the disclosed technology includes a general purpose computing device in the form of a computer 510. Components of computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 510 typically includes a variety of computer readable media. Computer readable media can be any available media that can be accessed by computer 510 and includes both volatile and nonvolatile media, removable and non-removable media. By way of example, and not limitation, computer readable media may comprise computer storage media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 510.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 13 illustrates operating system 534, application programs 535, other program modules 536, and program data 537.

The computer 510 may also include other removable/non-removable, volatile/nonvolatile computer storage media. By way of example, FIG. 13 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media (or computer storage medium) discussed herein and illustrated in FIGS. 12-14, provide storage of computer readable instructions, data structures, program modules and other data for the computer 510. In FIG. 13, for example, hard disk drive 541 is illustrated as storing operating system 544, application programs 545, other program modules 546, and program data 547. Note that these components can either be the same as or different from operating system 534, application programs 535, other program modules 536, and program data 537. Operating system 544, application programs 545, other program modules 546, and program data 547 are given different numbers here to illustrate that, at a minimum, they are different copies. A user may enter commands and information into the computer 510 through input devices such as a keyboard 562 and pointing device 561, commonly referred to as a mouse, trackball or touch pad. Other input devices (not shown) may include a microphone, joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. In addition to the monitor, computers may also include other peripheral output devices such as speakers 597 and printer 596, which may be connected through an output peripheral interface 590.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 13. The logical connections depicted in FIG. 13 include a local area network (LAN) 571 and a wide area network (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560, or other appropriate mechanism. In a networked environment, program modules depicted relative to the computer 510, or portions thereof, may be stored in the remote memory storage device. By way of example, and not limitation, FIG. 13 illustrates remote application programs 585 as residing on memory device 581. It will be appreciated that the network connections shown are exemplary and other means of establishing a communications link between the computers may be used.

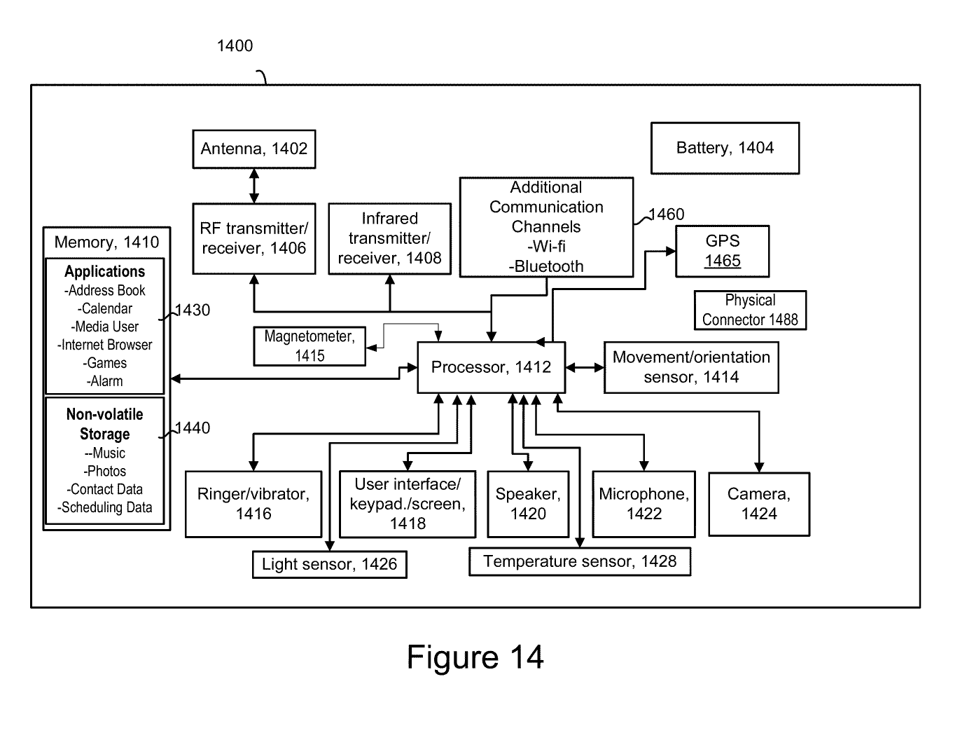

FIG. 14 depicts an example block diagram of a mobile device for implementing the operations of the disclosed technology. Exemplary electronic circuitry of a typical mobile phone is depicted. The mobile device 1400 includes one or more microprocessors 1412, and memory 1410 (e.g., non-volatile memory such as ROM and volatile memory such as RAM) which stores processor-readable code which is executed by one or more processors of the control processor 1412 to implement the functionality described herein.

Mobile device 1400 may include, for example, processors 1412, memory 1410 including applications and non-volatile storage. The processor 1412 can implement communications, as well any number of applications, including the applications discussed herein. Memory 1410 can be any variety of memory storage media types, including non-volatile and volatile memory. A device operating system handles the different operations of the mobile device 1400 and may contain user interfaces for operations, such as placing and receiving phone calls, text messaging, checking voicemail, and the like. The applications 1430 can be any assortment of programs, such as a camera application for photos and/or videos, an address book, a calendar application, a media user, an internet browser, games, an alarm application or other third party applications. The non-volatile storage component 1440 in memory 1410 contains data such as web caches, music, photos, contact data, scheduling data, and other files.

The processor 1412 also communicates with RF transmit/receive circuitry 1406 which in turn is coupled to an antenna 1402, with an infrared transmitted/receiver 1408, and with a movement/orientation sensor 1414 such as an accelerometer and a magnetometer 1415. Accelerometers have been incorporated into mobile devices to enable such applications as intelligent user interfaces that let users input commands through gestures, indoor GPS functionality which calculates the movement and direction of the device after contact is broken with a GPS satellite, and to detect the orientation of the device and automatically change the display from portrait to landscape when the phone is rotated. An accelerometer can be provided, e.g., by a micro-electromechanical system (MEMS) which is a tiny mechanical device (of micrometer dimensions) built onto a semiconductor chip. Acceleration direction, as well as orientation, vibration and shock can be sensed. The processor 1412 further communicates with a ringer/vibrator 1416, a user interface keypad/screen 1418, a speaker 1420, a microphone 1422, a camera 1424, a light sensor 1426 and a temperature sensor 1428. Magnetometers have been incorporated into mobile devices to enable such applications as a digital compass that measure the direction and magnitude of a magnetic field in the vicinity of the mobile device, track changes to the magnetic field and display the direction of the magnetic field to users.

The processor 1412 controls transmission and reception of wireless signals. During a transmission mode, the processor 1412 provides a voice signal from microphone 1422, or other data signal, to the transmit/receive circuitry 1406. The transmit/receive circuitry 1406 transmits the signal to a remote station (e.g., a fixed station, operator, other cellular phones, etc.) for communication through the antenna 1402. The ringer/vibrator 1416 is used to signal an incoming call, text message, calendar reminder, alarm clock reminder, or other notification to the user. During a receiving mode, the transmit/receive circuitry 1406 receives a voice or other data signal from a remote station through the antenna 1402. A received voice signal is provided to the speaker 1420 while other received data signals are also processed appropriately.

Additionally, a physical connector 1488 can be used to connect the mobile device 1400 to an external power source, such as an AC adapter or powered docking station. The physical connector 1488 can also be used as a data connection to a computing device. The data connection allows for operations such as synchronizing mobile device data with the computing data on another device. A global positioning service (GPS) receiver 1465 utilizing satellite-based radio navigation to relay the position of the user applications is enabled for such service.

As noted above, one implementation of this technology includes a library used by applications in order to trigger events and push them into the transformation flow. Service 102 includes a client-server API i to accept streams of events from applications and ingest them into a cloud-based transformation pipeline managed by service 102. The event service 102 accepts incoming events and applies transformations and aggregations to provide statistics. The statistics are then stored in a datastore and values are also forwarded to other services.

The repository data system 140 creates a historical archive that can be queried and used to generate reports showing events/values over time. The real time event service 102 exposes APIs that allow calculated values to be retrieved by other internal and external clients and services. The real time data system 110 takes a calculated value feed and allows clients and services to subscribe to change notifications of those values.

In an alternative implementation, rather than using local event transformation may be utilized. Local transformation may be full or partial. Rather than all events generated on processing devices being pushed to event service 102, one or more transformation components may run on a processing device 100 and distribute events and statistics to other processing devices 100. No communication need take place with a host event service 102 directly to clients; no communication takes place with a hosted service. These embodiment significantly decreases the latency of event and statistic distribution since it may take place over a local network or wireless connection.

The two implementations above could even be present at the same time and serve different companion applications at the same time (some of which are connected to the host application, others which are analyzing the historical store, and another group which are subscribed to real time changes to the calculated values).

In yet another embodiment, event definitions need not be provided by application developers or the service 102. In such case, each event may be self-describing. Transformation rules would look at the structure of each event and apply their rules using a pattern-based approach.

The technology allows firing a high-level set of events with minimal effort on the part of the primary application developer and shifts the burden of extensibility, onto the transformation system that is described by this technology. This decoupling also provides an integration point for third parties: the output of the transformation system could be made available to other developers and those developers could build experiences on top of the host application without the involvement of the developers of the host application.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer readable medium including code instructing a processing device to perform a computer implemented method comprising:
determining whether a user would benefit from assistance in using a primary computing application executing on a first computing device;
determining a context of use of the primary computing application by the user, the context defined at least by an issue troubling the user in the use of the application;
formulating a search query including key terms relating to the context;
executing the search query to retrieve publically available network resident help information relating to the issue;
outputting search results to a display; and
responsive to user selection of a search result, rendering the help information in the display.

2. The computer readable medium of claim 1 wherein the executing includes submitting the search query to a publically available search engine.

3. The computer readable medium of claim 1 wherein the executing includes running the search query against a database of gathered publicly available network resident help.

4. The computer readable medium of claim 1 wherein determining a context includes receiving an output from the primary application identifying one or more query terms in a query term table.

5. The computer readable medium of claim 4 wherein the query term table includes a series of entries comprising terms developed for a query on the primary application.

6. The computer readable medium of claim 1 wherein the determining a context includes receiving event data from a real time event data system and determining context from the event data.

7. The computer readable medium of claim 1 wherein the method is performed on a second computing device, the second computing device accessible to the user.

8. The computer readable medium of claim 1 wherein the context includes one or more tasks for completion by a user within the application context, said determining a whether the user would benefit from help including determining the user cannot complete at least one of the one or more tasks.

9. A system rendering help information to a user on a display, comprising:
a display; and
a processor and code instructing the processor to perform a method comprising:
determining a user help requirement in using a primary computing application;
determining a context of use of the application by the user and the user help requirement in the context;
submitting the search query including key terms relating to the context for execution to retrieve publically available network resident help information relating to the issue; and
responsive to user selection of a search result rendered in the display, rendering the help information in the display.

10. The system of claim 9 wherein the user help requirement includes help in completing one or more tasks by a user within the application context, said determining a whether the user would benefit from help including determining the user cannot complete at least one of the one or more tasks.

11. The system of claim 10 wherein the submitting the search query includes submitting the search query to a database, the database created by executing a search query against publically available network information from third parties illustrating completion of the one or more tasks.

12. The system of claim 11 further including retrieving publically available network help information from one or more public network resources identified by the search.

13. The system of claim 9 wherein the primary application is executed on a first computing device, the system in communication with the first computing device.

14. The system of claim 13 wherein the system receives event data from a real time event data system operating on a second computing device.

15. The system of claim 13 wherein the system communicates directly with the first computing device and receives an output from the primary application identifying one or more query terms in a query term table on the system.

16. A game apparatus coupled to a display, comprising:
a processor and a memory, the memory including code instructing the processor, the code instructing the processor to:
execute a primary game application, the game application having a context and one or more tasks for completion by a user within the game context;
determine a user would benefit from assistance in completing any of the one or more tasks in the game;
execute a search query including key terms relating to the context, the search query executed to retrieve publically available network resident help information relating to the one or more tasks; and
output search results to a display.

17. The apparatus of claim 16 wherein the search query is submitted to a database, the database created by executing a search query against publically available network information from third parties illustrating completion of the one or more tasks.

18. The apparatus of claim 16 wherein the search query is submitted to publically available network help information from one or more public network resources identified by the search.

19. The apparatus of claim 16 wherein the code instructs the processor to access one or more query terms in a query term table, the query term table associated with the primary application and having a plurality of query strings used to formulate the search query.

20. The apparatus of claim 17 wherein the query term table includes a series of entries comprising terms developed for a query on the primary application.
